(19) United States
(12) Patent Application Publication
(10) Pub. No.: US 2012/0251755 A1
(43) Pub. Date: Oct. 4, 2012

(54) Flexible Transfer Film and Its Production Methods thereof

(76) Inventor: Tzu Te Yang, New Taipei City (TW)

(21) Appl. No.: 13/078,259

(22) Filed: Apr. 1, 2011

(51) Int. Cl. B44C 1/17; B32B 38/10

(52) U.S. Cl. 428/41.8; 428/195.1; 156/247

(57) ABSTRACT

The invention discloses a flexible transfer film, including a ductile flexible film wherein the film is able to extend and attach to the surface of the irregular objects; a ductile pattern layer wherein the pattern layer attaches to the surface of the flexible film and is able to attach to the surface of the irregular objects along with the extension of the flexible film. The flexible transfer film of the invention using the ductile flexible film and pattern layer, by stretching and adsorbing, the transfer film attaches to the inner face of the mold of the rigid objects so as to form in a piece with the rigid objects, and by the temperature and viscosity in forming the plastic objects to transfer the pattern layer of the flexible transfer film into the surface of the objects, so that even in the surface of the irregular objects, the transfer of the pattern to the surface is able to be realized. The invention could reduce the pollution and is energy saving, so as to decrease the environmental pollution and harm to human body; furthermore the flexible transfer film of the invention has merits of low temperature, energy saving, high rate of final products, so as to greatly reduce the production cost. Meanwhile, the invention also discloses the method to produce the flexible transfer film.

### TECHNICAL FIELD

The invention refers to a surface treatment material for objects, especially refers to a flexible transfer film that is able to transfer the pattern into the surface of the objects especially the irregular objects, meanwhile it refers to the production methods of the flexible transfer film.

### BACKGROUND ART

With the rapid development of the economy and the advancement of the technology, all kinds of innovative and beautiful designs pouring into our work, life even entertainment. To satisfy our needs for the increasing individual pursuits, we have wrack our brains' to find ways for the surface treatment for the products. Currently, the surface treatment process for the industrial products, usually by adopting the spray painting, electroplating and so on, however, and such technics consumes excessive energy, causes great pollution, and polluting and harming the environment and human body. Therefore, we are seeking for the energy-conserving and environment-protective methods for the surface treatment, to decrease the pollution to the environment and harm to human body. Taiwan LUXING Co., Ltd is among one of them, for decades since its establishment, the company and its subsidiary companies has doing the surface treatment for the flexible facings such as clothing, leather, plastic cement and so on, by using the colors like gold, silver and so on, to realize people's desire for dressing up in diamonds. However such methods could not be applied to the surface treatment in the plastic cement rigid objects, especially in the surface of those irregular objects.

In order to solve the diversity needs of the rigid objects for surface treatment, people adopt several craft for surface treatment, among which the heat transfer printing and water transfer printing is the most common way for surface treatment. The heat transfer printing needs to print the pattern for transfer into the surface of the special film such as thermal transfer paper and so on. The heat transfer printing solves the printing problem for the surface of some objects, but it could only be printed in the objects that are plane or cylinder. Since it requests to operate under high temperature and high pressure, the objects are easily be deformed or the pattern and color changed; the heat transfer printing could not decorate in the surface of the irregular objects especially the objects with rough and uneven in surface, meanwhile it needs to buy the expensive equipment. As for the water transfer print which is a technology for transfer printing by using the water pressure to coat the picture and text into the surface of the objects. Though the water transfer print could print the patterns into the surface of the irregular objects, but the water transfer print is mainly rely to handiwork, the production rate is extremely low, and the printed pattern is easier to deform and easier to fall off for its attachment with object surface is not very tight. Naturally, we also use the printer to print the pattern in the surface of objects, but the problem with some industrial rigid objects still remain unsolved, especially for the surface treatment of the irregular rigid objects, to make the pattern or color in the surface various and personalized.

Content of the Invention

Aiming at the shortcomings above in existing technology, the invention is to provide a flexible transfer film that is able to transfer the pattern into the surface of various rigid objects, especially for the irregular objects.

The other aim of the invention is to provide the production methods of the flexible transfer film

For achieving the objective above, this invention adopts the following technical solution:

A flexible transfer film, characterized in that it comprising:

a ductile flexible film wherein the film is able to extend and attach to the surface of the irregular objects;

a ductile pattern layer wherein the pattern layer attaches to the surface of the flexible film and is able to attach to the surface of the irregular objects along with the extension of the flexible film.

The foresaid flexible film is Thermoplastic polyurethanes (hereinafter refers as TPU) film or Polyvinyl chloride (hereinafter refers as PVC) or Polyethylene (hereinafter refers as PE), which is able to evenly attach to the surface of the objects by stretching and adsorbing.

The foresaid flexible transfer film also includes a release film wherein the release film attaches to the other face of the pattern layer.

The foresaid pattern layer and the flexible film have a release layer.

A method to produce the flexible transfer film including the following steps:

A. preparing a rigid base film, adopting the industrial production methods to attach the ductile pattern layer evenly to the rigid base film;

B. using the coating equipment to coat the glue layer in the other side of the pattern layer;

C. using compound device to compound the flexible film to the surface of the glue layer, so as to form the compound film;

D. After the glue layer dried, stripped the rigid base film, and then come the flexible transfer film.

The foresaid rigid base file is Polyethylene terephthalate (hereinafter refers as PET) film; the flexible film is TPU film.

The industrial production methods include printing, gilding or recombination.

A method to produce the flexible transfer film as set forth in claim 1, including the following steps:

A. preparing a rigid base film, adopting the industrial production methods to attach the ductile pattern layer evenly to the rigid base film;

B. heating the rigid base film which attached with the ductile pattern layer to 90 to 110 degree Celsius, by using the compound device to compound the ductile flexible film with the ductile pattern lawyer;

C. Stripping the rigid base film, and then come the flexible transfer film.

The foresaid method as in Step B after heating the rigid base film, using the coating equipment to coat the glue layer in the other side of the pattern layer; then using compound device to combine the ductile flexible film to the pattern layer.

The foresaid rigid base file is PET film; the flexible film is TPU film; the industrial production methods includes printing, gilding or recombination

By adopting the above solutions, The flexible transfer film of the invention using the ductile flexible film and pattern layer, by stretching and adsorbing, the transfer film attaches to the inner face of the mold of the rigid objects so as to form in a piece with the rigid objects, and by the temperature and viscosity in forming the plastic objects to transfer the pattern layer of the flexible transfer film into the surface of the objects, so that even in the surface of the irregular objects, the transfer of the pattern to the surface is able to be realized. Apparently, by using flexible transfer film formed objects do not need to apply to the painting process, which reduce the pollution and energy saving, so as to decrease the environmental pollution and harm to human body; furthermore the flexible transfer film of the invention has merits of low temperature, energy saving, high rate of final products, so as to greatly reduce the production cost. Meanwhile, the invention also discloses the method to produce the flexible transfer film.

### DESCRIPTION OF FIGURES

FIG. 1 is the structural schematic view of the flexible transfer film of the invention;

FIG. 2 is the structural schematic view of Embodiment 2 of the flexible transfer film of the invention;

FIG. 3 is the structural schematic view of Embodiment 3 of the flexible transfer film of the invention;

FIG. 4 is the process flow diagram of the flexible transfer film of the invention;

FIG. 5 is the process flow diagram of Embodiment 2 of the flexible transfer film of the invention;

FIG. 6 is the process flow diagram of Embodiment 3 of the flexible transfer film of the invention.

### MODE OF CARRYING OUT THE INVENTION

Further explanation to the invention is stated below combining with the attached figures:

### Embodiment 1

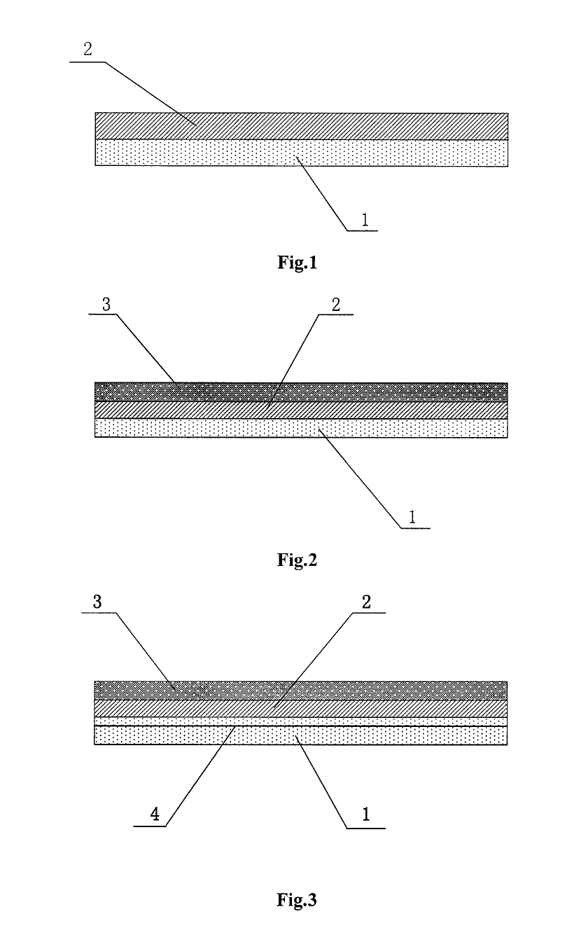

As shown in FIG. 1, a flexible transfer film including a ductile flexible film 1 and a ductile pattern layer 2; the flexible film 1 is able to extend and attach to the surface of the irregular objects, commonly the material for flexible film 1 is TPU film or PVC film or PE film. The pattern layer 2 attaches to the surface of the flexible film 1 and is able to attach to the surface of the irregular objects along with the extension of the flexible film 1. Naturally, in the embodiment, in order to protect the pattern layer 2, we could set a release film 3 (as shown in FIG. 2) in the other side of the pattern layer 2, or in practice, in order to be convenient for stripping the flexible film 1, we could set a release layer 4 (as shown in FIG. 3) between the flexible film 1 and the pattern layer 2.

### Embodiment 2

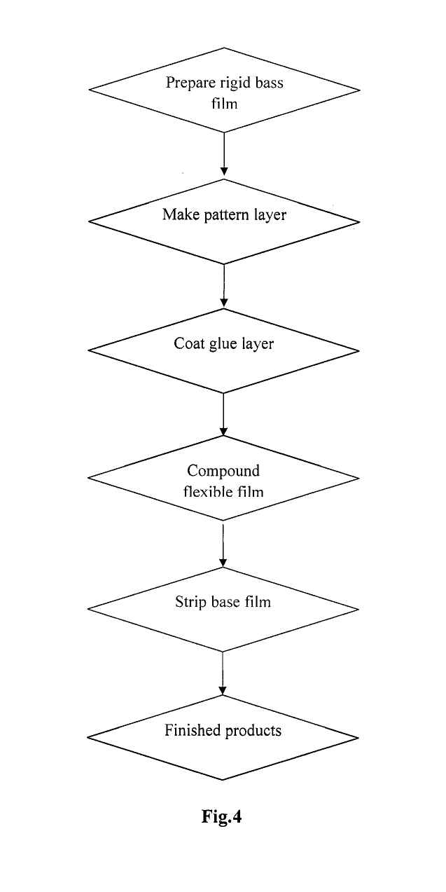

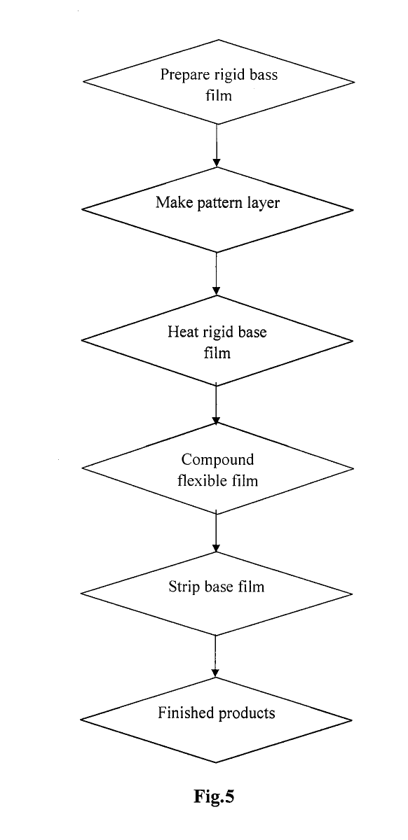

As shown in FIG. 4, A method to produce the flexible transfer film including the following steps:

A. preparing a rigid PET base film, adopting the industrial production methods to attach the ductile pattern layer evenly to the rigid base film;

B. using the coating equipment (optimally the coating equipment manufactured by SEADANG New Material (Shenzhen) Co., Ltd) to coat the glue layer in the other side of the pattern layer;

C. using compound device (optimally the compound device manufactured by SEADANG New Material (Shenzhen) Co., Ltd) to compound the flexible film to the surface of the glue layer, so as to form the compound film;

D. After the glue layer dried, stripped the rigid PET base film, and then come the flexible transfer film.

By adopting the above method to produce the flexible film, by using the rigid PET film with the merits of surfacing, deformation resistance, easy printing and so on, firstly print the ductile pattern layer in the rigid PET base film, then by using the coating glue with the combination of the TPU flexible film to transfer the pattern in the PET into the TPU flexible film, so as to ensure the deformation of the pattern layer; after that by stretching and adsorbing the TPU flexible transfer film attaches to the surface of the rigid objects (including the surface of irregular objects), naturally make the transfer film attaches to the inner face of the mold of the objects so as to form in a piece with the objects, in the way the process for the surface treatment of objects is simple, unpolluted and has high production rate.

### Embodiment 3

As shown in FIG. 5, a method to produce the flexible transfer film, including the following steps:

A. preparing a rigid PET base film, adopting the industrial production methods to attach the ductile pattern layer evenly to the rigid PET base film;

B. heating the rigid PET base film which attached with the ductile pattern layer to 90 to 110 degree Celsius, by using the compound device to combine the ductile TPU flexible film with the ductile pattern lawyer; naturally, we could choose the PVC or the PE flexible film;

C. Stripping the rigid PET base film, and then come the flexible transfer film.

By adopting the above method to produce the flexible film, by using the rigid PET film with the merits of surfacing, deformation resistance, easy printing and so on, firstly print the ductile pattern layer in the rigid PET base film, then by using the heating to transfer the pattern in the PET into the TPU flexible film, so as to ensure the deformation of the pattern layer; after that by stretching and adsorbing the TPU flexible transfer film attaches to the surface of the rigid objects (including the surface of irregular objects), naturally make the transfer film attaches to the inner face of the mold of the objects so as to form in a piece with the objects, in the way the process for the surface treatment of objects is simple, unpolluted and has high production rate.

### Embodiment 4

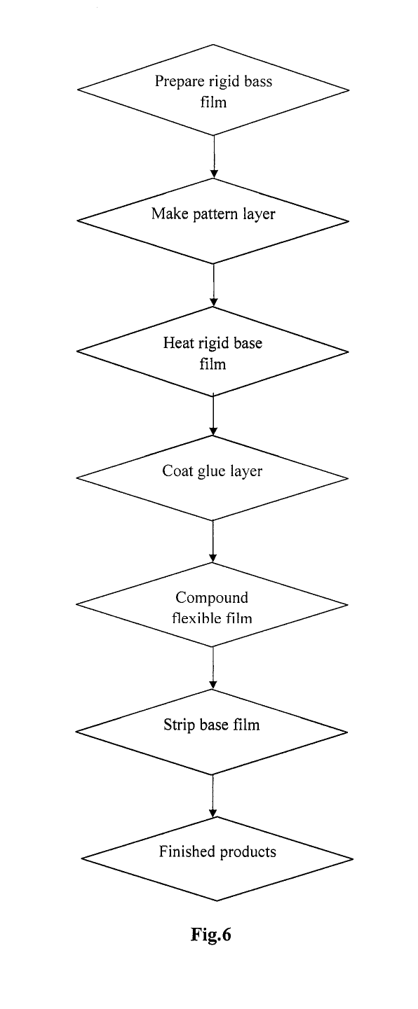

As shown in FIG. 6, A method to produce the flexible transfer film, including the following steps:

A. preparing a rigid PET base film, adopting the industrial production methods to attach the ductile pattern layer evenly to the rigid base film;

B. heating the coated rigid base film that attached with the ductile pattern layer to 90 to 110 degree Celsius, using the coating equipment to coat the glue layer in the other side of the pattern layer;

C. using compound device to compound the flexible film to the surface of the glue layer, so as to form the compound film;

D. stripping the rigid base film, and then come the flexible transfer film.

By adopting the above method to produce the flexible film, by using the rigid PET film with the merits of surfacing, deformation resistance, easy printing and so on, firstly print the ductile pattern layer in the rigid PET base film, then by using the heating and coating glue layer to transfer the pattern in the PET into the TPU flexible film, so as to ensure the deformation of the pattern layer; after that by stretching and adsorbing the TPU flexible transfer film attaches to the surface of the rigid objects (including the surface of irregular objects), naturally make the transfer film attaches to the inner face of the mold of the objects so as to form in a piece with the objects, in the way the process for the surface treatment of objects is simple, unpolluted and has high production rate.

Naturally, in the embodiments of the invention, in order to enrich the styles of the pattern layer, we could add the dyestuff or laser, so that the colors of the transferred pattern is more rich and colorful, to satisfy the individual requirements of people.

It should be understood that the decryptions for the above embodiments are very detailed, but it could not be regarded as the limitation for the protection of the invention, the protection ranges for the invention should be subject to the claim as attached.

What is claimed is:

1. A flexible transfer film, characterized in that it comprising:
a ductile flexible film wherein the film is able to extend and attach to the surface of the irregular objects;
a ductile pattern layer wherein the pattern layer attaches to the surface of the flexible film and is able to attach to the surface of the irregular objects along with the extension of the flexible film.

2. The flexible transfer film as set forth in claim 1, characterized in that the foresaid flexible film is one of Thermoplastic polyurethanes (TPU) film or Polyvinyl chloride (PVC) film or Polyethylene (PE) film, which is able to evenly attach to the surface of the objects by stretching and adsorbing.

3. The flexible transfer film as set forth in claim 1, characterized in that the foresaid flexible transfer film also includes a release film wherein the release film attaches to the other face of the pattern layer.

4. A flexible transfer film as set forth in claim 1, characterized in that the foresaid pattern layer and the flexible film has a release layer.

5. A method to produce the flexible transfer film as set forth in claim 1, including the following steps:
A. Preparing a rigid base film; adopting the industrial production methods to attach the ductile pattern layer evenly to the rigid base film;
B. using the coating equipment to coat the glue layer in the other side of the pattern layer;
C. using compound device to compound the flexible film to the surface of the glue layer, so as to form the compound film;
D. After the glue layer dried, stripped the rigid base film, and then come the flexible transfer film.

6. A method to produce the flexible transfer film as set forth in claim 5, characterized in that the foresaid rigid base film is Polyethylene terephthalate (PET) film; the foresaid flexible film is Thermoplastic polyurethanes (TPU) film.

7. A method to produce the flexible transfer film as set forth in claim 5, characterized in that the industrial production methods includes printing, gilding or recombination.

8. A method to produce the flexible transfer film as set forth in claim 1, including the following steps:
A. preparing a rigid base film; adopting the industrial production methods to attach the ductile pattern layer evenly to the rigid base film;
B. heating the rigid base film which attached with the ductile pattern layer to 90 to 110 degree Celsius, by using the compound device to compound the ductile flexible film with the ductile pattern lawyer;
C. Stripping the rigid base film, and then come the flexible transfer film.

9. A method to produce the flexible transfer film as set forth in claim 8, including the following steps:
A. preparing a rigid base film, adopting the industrial production methods to attach the ductile pattern layer evenly to the rigid base film;
B. heating the coated rigid base film that attached with the ductile pattern layer to 90 to 110 degree Celsius, using the coating equipment to coat the glue layer in the other side of the pattern layer;
C. using compound device to compound the flexible film to the surface of the glue layer, so as to form the compound film;
D. stripping the rigid base film, and then come the flexible transfer film.

10. A method to produce the flexible transfer film as set forth in claim 8, characterized in that the foresaid rigid base file is Polyethylene terephthalate (PET) film; the flexible film is Thermoplastic polyurethanes (TPU) film; the industrial production methods includes printing, gilding or recombination.

11. A method to produce the flexible transfer film as set forth in claim 9, characterized in that the foresaid rigid base file is Polyethylene terephthalate (PET) film; the flexible film is Thermoplastic polyurethanes (TPU) film; the industrial production methods includes printing, gilding or recombination
